(19) United States
(12) Patent Application Publication
(10) Pub. No.: US 2026/0168458 A1
(43) Pub. Date: Jun. 18, 2026

(54) INJECTION VALVE FOR FUELS, CYLINDER HEAD WITH INJECTION VALVE, METHOD FOR INSTALLING AN INJECTION VALVE INTO A CYLINDER HEAD, AND USE OF A CYLINDRICAL RECEPTACLE OF A CYLINDER HEAD AS THE OUTER SHELL OF AN INJECTION VALVE

(71) Applicant: Robert Bosch GmbH, Stuttgart (DE)

(72) Inventors: Christian Graspeuntner, Hallein (AT); Walter Walkner, Anif (AT); Martin Rainer, Tamsweg (AT)

(21) Appl. No.: 19/109,275

(22) PCT Filed: Sep. 4, 2023
(86) PCT No.: PCT/EP2023/074118

§ 371 Date: Mar. 6, 2025

(30) Foreign Application Priority Data
Sep. 7, 2022 (DE) 10 2022 209 290.2

(51) Int. Cl. F02F 1/40; F02F 1/24; F02M 51/06; F02M 61/14; F02M 61/16

(52) U.S. Cl. CPC F02F 1/40; F02F 1/242; F02M 51/0671; F02M 61/14; F02M 61/168

(57) ABSTRACT

The invention relates to an injection valve (1) for fuels, in particular for liquid fuels, such as methanol, and/or for gaseous fuels, such as natural gas or hydrogen, for installation in a cylindrical receptacle (7) of a cylinder head (6), wherein the injection valve (1) has a body component (4) with an outer circumferential recess (3), which, after installation of the injection valve (1), together with the cylindrical receptacle (7) of the cylinder head (6) forms an inlet path (2) designed as an annular space for a fuel.

The invention further relates to a cylinder head (6) with an injection valve (1) according to the invention, a method for installing an injection valve (1) according to the invention into a cylinder head (6), and a use of a cylindrical receptacle (7) of a cylinder head (6) as the outer shell of an injection valve (1).

### BACKGROUND

The invention relates to an injection valve for fuels, in particular for liquid fuels, such as methanol, and/or for gaseous fuels, such as natural gas or hydrogen. The injection valve allows the fuels to be injected into a combustion chamber of an internal combustion engine. The injection valve is installed in a cylinder head of the internal combustion engine for this purpose.

The invention therefore further relates to a cylinder head with an injection valve according to the invention that is inserted into a cylindrical receptacle of the cylinder head. In addition, a method for installing an injection valve into a cylinder head, and use of a cylindrical receptacle of a cylinder head as the outer shell of an injection valve is proposed.

In the prior art, injection valves for liquid and/or gaseous fuels are described in a wide variety of embodiments. which generally comprise a nozzle body and a nozzle needle which is accommodated in the nozzle body for reciprocating movement, and whose reciprocating movements can be used to control at least one injection opening formed in the nozzle body. The fuel enters the at least one injection opening via an internal inlet channel, which generally extends not only via the nozzle body, but also via a retaining body of the injection valve that is axially attached to the nozzle body and connected to it via a nozzle clamping nut. In addition to a nozzle body and a retaining body, the injection valve may have further body components that are clamped together by means of the nozzle clamping nut.

To inject alternative fuels, in particular liquid fuels, such as methanol, and/or gaseous fuels, such as natural gas or hydrogen, large inlet cross-sections are required due to a generally lower inlet pressure and/or lower energy density of the fuel, as otherwise the required flow rate of fuel cannot be achieved. Larger inlet cross-sections generally require larger outer diameters, which negatively impact the space requirement of the injection valve.

### SUMMARY

The present invention addresses the task of further developing an injection valve for fuels, in particular for alternative fuels, in such a way that a larger inlet cross-section is created for the respective fuel while keeping the space requirement as unchanged as possible.

Proposed in order to achieve said object are the injection valve according to the disclosure, the cylinder head according to the disclosure and the method according to the disclosure. Furthermore, the use of a cylindrical receptacle of a cylinder head as the outer shell of an injection valve is proposed.

The injection valve proposed for fuels, in particular for liquid fuels such as methanol, and/or for gaseous fuels, such as natural gas or hydrogen, is designed to be installed in a cylindrical receptacle of a cylinder head. The injection valve has a body component with an outer circumferential recess that, after installation of the injection valve, forms an inlet path designed as an annular space for a fuel together with the cylindrical receptacle of the cylinder head.

In the proposed injection valve, the cylindrical receptacle of the cylinder head serves as the outer shell of the injection valve. Until the injection valve is installed in the cylindrical receptacle of the cylinder head, the inlet path in the area of the outer circumferential recess of the body component of the injection valve is not enclosed by an outer shell, as there is no such shell. The absence of the outer shell allows for an increase in the inlet cross-section of the inlet path while maintaining the outer diameter of the injection valve, ensuring that the space requirement of the injection valve remains unchanged.

After installing the injection valve into the cylindrical receptacle of the cylinder head, the receptacle and the outer circumferential recess of the body component of the injection valve form an inlet path designed as an annular space. The configuration of the inlet path as an annular space, also as an external annular space that extends to the outer diameter of the injection valve, enables the inlet cross-section to be maximized.

The proposed injection valve is in particular suitable for injecting alternative fuels, such as methanol, natural gas, or hydrogen, as the increased inlet cross-section of the inlet path can compensate for the lower inlet pressure and/or lower energy density of such fuels.

According to a preferred embodiment of the invention, the inlet path is configured as an internal inlet channel upstream and downstream of the outer circumferential recess of the body component. In other words, the inlet path also has internal sections. The fuel can be introduced into the section designed as an annular space and discharged again via the internal sections in order to feed the fuel to at least one injection opening of the injection valve.

Furthermore, the inlet path is preferably divided into at least two substantially parallel paths at least in sections. This measure can further increase the inlet cross-section. Preferably, an internal inlet channel forms a first path and the annular space, which is formed by the outer circumferential recess together with the cylindrical receptacle, forms a second path. The internal inlet channel is then extended by the external annular space.

Preferably, the injection valve has at least one external sealing ring. The sealing ring can be used to seal the inlet path outwardly after installation of the injection valve into the cylindrical receptacle of the cylinder head. Preferably, at least one sealing ring is provided on both sides of the outer circumferential recess of the body component, such that the annular space is later sealed at both ends.

Furthermore, a cylinder head for an internal combustion engine with a cylindrical receptacle is proposed. An injection valve according to the invention for injecting fuel into a combustion chamber of the internal combustion engine is inserted into the cylindrical receptacle, such that the cylindrical receptacle and the body component of the injection valve having the external circumferential recess, together form the inlet path designed as an annular space. The inlet path is thus radially outwardly limited by the cylindrical receptacle of the cylinder head, such that the cylindrical receptacle replaces the missing outer shell of the injection valve. The inlet path is therefore enclosed on all sides and can be supplied with fuel.

Preferably, the cylindrical receptacle is formed by a water sleeve integrated into the cylinder head, which separates the inlet path designed as an annular space from a cooling water channel formed in the cylinder head. The purpose of a water sleeve integrated into the cylinder head is typically to seal the cooling water channel formed in the cylinder head from the combustion chamber. The cooling water flowing via the cooling water channel is needed to cool the injection valve. In a cylinder head according to the invention, the water sleeve has an additional purpose. This purpose is to replace the missing outer shell of the injection valve. The space gained in the injection valve is used as the inlet cross-section.

During operation of the injection valve, the water sleeve is therefore exposed to fuel on one side and cooling water on the other. Accordingly, the tightness requirements and the requirements for reliable media separation increase.

As a further improvement measure, it is proposed that at least one sealing ring is arranged between the water sleeve and the cylinder head. The at least one sealing ring seals the cooling water channel outwardly and towards the combustion chamber. To seal the inlet path designed as an annular space, at least one external sealing ring of the injection valve can be used, which abuts the water sleeve of the cylinder head under radial preload. Preferably, the injection valve has at least two external sealing rings arranged on both sides of the annular space. In this way, reliable media separation can be achieved at the same time.

In a further proposed method for installing an injection valve according to the invention in a cylinder head, the injection valve is inserted into a cylindrical receptacle of the cylinder head, such that the cylindrical receptacle and the body component of the injection valve having the outer circumferential recess together form the inlet path designed as an annular space. When the injection valve is installed into the cylinder head, the cylindrical receptacle of the cylinder head replaces the missing outer shell of the injection valve. The elimination of the outer shell and the formation of the inlet path as an annular space enables large inlet cross-sections without changing the required installation space of the injection valve.

As a further design measure, it is proposed that, to form the cylindrical receptacle and to seal a cooling water channel formed in the cylinder head, a water sleeve is inserted into the cylinder head before installing the injection valve. After installing the injection valve, the water sleeve separates the inlet path designed as an annular space from the cooling water channel. The water sleeve thus serves to simultaneously separate the cooling water and fuel media.

Advantageously, at least one sealing ring is arranged between the injection valve and the cylindrical receptacle of the cylinder head or the water sleeve forming the cylindrical receptacle. The at least one sealing ring can be used to seal the inlet path designed as an annular space, such that the tightness of the injection valve is ensured. Preferably, at least one sealing ring is placed on both sides of the annular space.

Moreover, it is proposed to use a cylindrical receptacle of a cylinder head, preferably formed by a water sleeve integrated into the cylinder head, as the outer shell of an injection valve according to the invention inserted into the cylinder head. The outer shell missing from the injection valve according to the invention is then replaced by the cylindrical receptacle of the cylinder head or the water sleeve integrated into the cylinder head.

### BRIEF DESCRIPTION OF THE DRAWINGS

A preferred embodiment of the invention is explained in more detail below with reference to the accompanying drawings. Shown are:

FIG. 1 a schematic longitudinal section through an injection valve according to the invention and

FIG. 2 shows a schematic longitudinal section through the injection valve of FIG. 1 showing the fuel guide.

### DETAILED DESCRIPTION

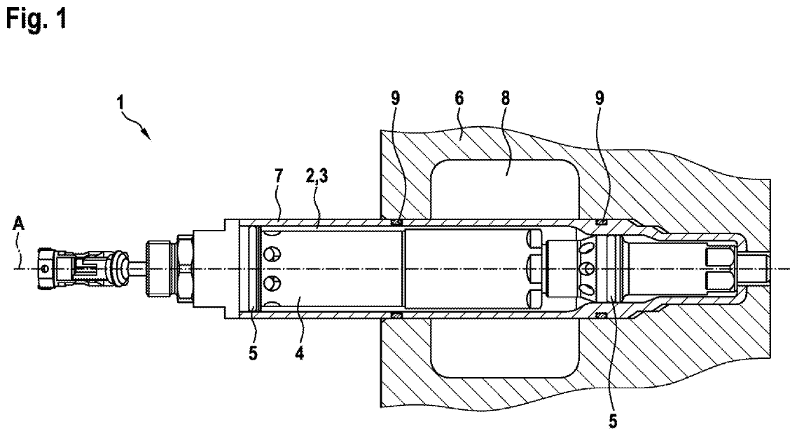

FIG. 1 shows an injection valve 1 for fuels inserted into a cylinder head 6 of an internal combustion engine. In cylinder head 6, a cooling water channel 8 is configured in the area of injection valve 1, which is outwardly sealed by a water sleeve and sealing rings 9 arranged between the water sleeve and cylinder head 6.

The water sleeve forms a cylindrical receptacle 7 into which injection valve 1 is inserted. The water sleeve replaces a missing outer shell of the injection valve 1. Instead of an outer shell, the injection valve 1 has a body component 4 with an outer circumferential recess 3, which forms an annular space together with the water sleeve of the cylinder head 6. An inlet path 2 of the injection valve 1 leads via the annular space, such that fuel can be fed via the annular space to at least one injection opening (not shown) of the injection valve 1.

Before inserting the injection valve 1 into the cylindrical receptacle 7 of cylinder head 6, the inlet path 2 is not enclosed on all sides. The inlet path 2 can therefore not be exposed to fuel before installing the injection valve 1. After installing the injection valve 1 into cylinder head 6, the water sleeve and sealing rings 5 arranged on the injection valve 1 seal the inlet path 2 outwardly.

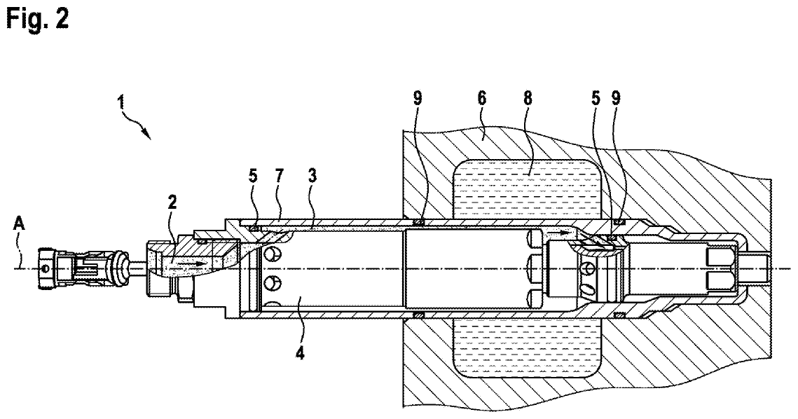

FIG. 2 shows the injection valve 1 from FIG. 1 during the exposure to fuel. The inlet path 2 is initially guided internally and then expands via the external annular space, which is formed by the outer circumferential recess 3 of the body component 4 and the cylindrical receptacle 7 in the form of the water sleeve. The annular space is adjoined by a further section of the inlet path 2, which is guided inwards again, in order to feed the fuel to the at least one injection opening (not shown) of the injection valve 1. The flow direction of the fuel is shown in FIG. 2 using arrows.

By guiding the inlet path 2 for the fuel to the outer diameter of the injection valve 1, the inlet cross-section of the inlet path 2 can be maximized. In this way, low inlet pressures and/or low energy densities of alternative fuels can be compensated for, making the injection valve 1 particularly suitable for injecting such fuels.

The terms “radially outwards” and “radially inwards” refer to an axis A, which forms the central longitudinal axis of the injection valve 1. The outer circumferential recess 3 in the body component 4 extends in the axial direction, that is, in a direction parallel to axis A. The sealing rings 5 arranged on both sides of the recess 3 are thus positioned at an axial distance from each other.

1. An injection valve (1) for liquid fuels or gaseous fuels for installation in a cylindrical receptacle (7) of a cylinder head (6), wherein the injection valve (1) has a body component (4) with an outer circumferential recess (3), which, after installation of the injection valve (1), together with the cylindrical receptacle (7) of the cylinder head (6) forms an inlet path (2) configured as an annular space for a fuel.

2. The injection valve (1) according to claim 1, wherein inlet path (2) is continued upstream and downstream of the recess (3) as an internal inlet channel.

3. The injection valve (1) according to claim 1, wherein the inlet path (2) is divided, at least in sections, into at least two substantially parallel-guided paths.

4. The injection valve (1) according to claim 1,
wherein the injection valve (1) has at least one external sealing ring (5).

5. The injection valve (1) according to claim 1,
wherein the fuel is a liquid fuel or a gaseous fuel.

6. A cylinder head (6) for an internal combustion engine having a cylindrical receptacle (7) in which an injection valve (1) according to claim 1 is inserted for injecting fuel into a combustion chamber of the internal combustion engine, such that the cylindrical receptacle (7) and the body component (4) of the injection valve (1) having the outer circumferential recess (3) form an inlet path (2) configured as an annular space.

7. The cylinder head (6) according to claim 6,
wherein the cylindrical receptacle (7) is formed by a water sleeve integrated into the cylinder head (6), which separates the inlet path (2) configured as an annular space from a cooling water channel (8) formed in the cylinder head (6).

8. The cylinder head (6) according to claim 7,
wherein at least one sealing ring (9) is arranged between the water sleeve and the cylinder head (6).

9. A method for installing an injection valve (1) according to claim 1 in a cylinder head (6), in which the injection valve (1) is inserted into a cylindrical receptacle (7) of the cylinder head (6), such that the cylindrical receptacle (7) and the body component (4) of the injection valve (1) having the outer circumferential recess (3) together form the inlet path (2) configured as an annular space.

10. The method according to claim 9,
wherein, to form the cylindrical receptacle (7) and to seal a cooling water channel (8) formed in the cylinder head (6), a water sleeve (7) is inserted into the cylinder head (6) before installing the injection valve (1).

11. The method according to claim 9,
wherein at least one sealing ring (5) is arranged between the injection valve (1) and the cylindrical receptacle (7).

12. A use of a cylindrical receptacle (7) of a cylinder head (6) as the outer shell of an injection valve (1) inserted into the cylinder head (6) according to claim 1.

13. The injection valve (1) according to claim 3, wherein an internal inlet channel forms a first path and the annular space formed by the recess (3) together with the cylindrical receptacle (7) forms a second path.

14. The injection valve (1) according to claim 4, wherein at least one sealing ring (5) is provided on both sides of the recess (3).

15. The injection valve (1) according to claim 5, wherein the liquid fuel is methanol or the gaseous fuel is natural gas or hydrogen.

16. The use of a cylindrical receptacle (7) according to claim 12, wherein the cylindrical receptacle is formed by a water sleeve integrated into the cylinder head (6).
